(19) United States
(12) Patent Application Publication
(10) Pub. No.: US 2020/0134873 A1
(43) Pub. Date: Apr. 30, 2020

(54) IMAGE PROCESSING DEVICE, COMPUTER PROGRAM, AND IMAGE PROCESSING SYSTEM

(71) Applicant: SUMITOMO ELECTRIC INDUSTRIES, LTD., Osaka-shi, Osaka (JP)

(72) Inventors: Michikazu UMEMURA, Osaka-shi (JP); Yuri KISHITA, Osaka-shi (JP)

(73) Assignee: SUMITOMO ELECTRIC INDUSTRIES, LTD., Osaka-shi, Osaka (JP)

(21) Appl. No.: 16/618,872

(22) PCT Filed: May 24, 2018
(86) PCT No.: PCT/JP2018/020061

§ 371 Date: Dec. 3, 2019

(30) Foreign Application Priority Data
Jul. 3, 2017 (JP) 2017-130194

(51) Int. Cl. G06T 7/90; H04N 5/235; H04N 9/04; G06T 7/70

(52) U.S. Cl. CPC G06T 7/90; H04N 5/2351; G06T 2207/10024; G06T 7/70; H04N 9/04

(57) ABSTRACT

This image processing device includes: an image acquisition unit configured to acquire a color image captured by a camera; a brightness determination unit configured to determine a brightness in an imaging range of the camera; a detection target color determination unit configured to determine, on the basis of a determination result by the brightness determination unit, detection target colors of two or more colors from among three or more colors provided to a label including regions of the three or more colors; and a label detection unit configured to detect the label by extracting, from the image acquired by the image acquisition unit, regions of the detection target colors determined by the detection target color determination unit.

### TECHNICAL FIELD

The present invention relates to an image processing device, a computer program, and an image processing system.

This application claims priority on Japanese Patent Application No. 2017-130194 filed on Jul. 3, 2017, the entire content of which is incorporated herein by reference.

### BACKGROUND ART

Conventionally, a label including a plurality of color regions is used in order to recognize an object. For example, Patent Literature 1 discloses, as an example of such a label, a two-dimensional code that includes a plurality of color regions each called a mark. Predetermined information is encoded in accordance with the color of the mark and the position of the mark included in the two-dimensional code. That is, the two-dimensional code represents predetermined information. Thus, a plurality of marks are detected from an image of a two-dimensional code captured by a camera, and on the basis of the colors of the detected marks and the positions of the detected marks, information can be decoded.

### CITATION LIST

### Patent Literature

Patent Literature 1: Japanese Laid-Open Patent Publication No. 2011-076395

### SUMMARY OF INVENTION

(1) An image processing device of the present disclosure includes: an image acquisition unit configured to acquire a color image captured by a camera; a brightness determination unit configured to determine a brightness in an imaging range of the camera; a detection target color determination unit configured to determine, on the basis of a determination result by the brightness determination unit, detection target colors of two or more colors from among three or more colors provided to a label including regions of the three or more colors; and a label detection unit configured to detect the label by extracting, from the image acquired by the image acquisition unit, regions of the detection target colors determined by the detection target color determination unit.

(7) A computer program of the present disclosure is configured to cause a computer to function as: an image acquisition unit configured to acquire a color image captured by a camera; a brightness determination unit configured to determine a brightness in an imaging range of the camera; a detection target color determination unit configured to determine, on the basis of a determination result by the brightness determination unit, detection target colors of two or more colors from among three or more colors provided to a label including regions of the three or more colors; and a label detection unit configured to detect the label by extracting, from the image acquired by the image acquisition unit, regions of the detection target colors determined by the detection target color determination unit.

(8) An image processing system of the present disclosure includes: a label including regions of three or more colors, the label configured to be attached to a detection target object; a camera configured to capture a color image; and the image processing device described above.

The present disclosure can be realized not only as an image processing device including such a characteristic processing unit, but also as an image processing method that includes, as steps, processes performed by the characteristic processing unit included in the image processing device. It is understood that the computer program described above can be distributed in the form of a computer-readable non-transitory storage medium such as a CD-ROM (Compact Disc-Read Only Memory), or via a communication network such as the Internet. The present disclosure can be realized also as a semiconductor integrated circuit that realizes a part or the entirety of the image processing device.

### BRIEF DESCRIPTION OF DRAWINGS

FIG. 1 shows a mounting example of an image processing system according to Embodiment 1.

FIG. 2 is a block diagram showing a configuration of the image processing system according to Embodiment 1.

FIG. 3A shows a helmet worn by a person, viewed sideways.

FIG. 3B shows the helmet worn by the person, viewed from above.

FIG. 4 shows expressions according to the Munsell color system (JISZ8721) of respective color labels.

FIG. 5 shows the spectral reflectance of each color label.

FIG. 6 shows a spectral distribution of sunlight.

FIG. 7 is a schematic diagram showing a label captured in a bright environment under sunlight.

FIG. 8 shows a spectral distribution of light of an incandescent lamp.

FIG. 9 is a schematic diagram showing a label captured in a dark environment under light of an incandescent lamp.

FIG. 10 shows one example of a brightness/darkness reference DB.

FIG. 11A shows one example of a green region and a red region on an image.

FIG. 11B shows one example of a green region and a red region on an image.

FIG. 12 is a flow chart showing a procedure of processes performed by an image processing device according to Embodiment 1.

FIG. 13 shows one example of a label attached to a helmet.

FIG. 14 is a flow chart showing a procedure of processes performed by the image processing device according to Embodiment 2.

FIG. 15 is a flow chart showing a procedure of processes performed by the image processing device according to a modification of Embodiment 2.

FIG. 16 is a block diagram showing a configuration of an image processing system according to Embodiment 2.

FIG. 17 shows one example of the brightness/darkness reference DB.

FIG. 18 is a block diagram showing a configuration of an image processing system according to Embodiment 3.

FIG. 19 shows one example of the brightness/darkness reference DB.

FIG. 20 shows one example of the brightness/darkness reference DB.

FIG. 21 shows a person viewed from the front.

FIG. 22 is an external view of a corrugated board box.

FIG. 23 is a schematic diagram showing a road on which a forklift travels.

### DESCRIPTION OF EMBODIMENTS

### Problem to be Solved by the Present Disclosure

However, the color of the mark is easily influenced by illumination. When a mark having a color is captured by a camera under different illumination, the mark may be captured as having a different color. Specifically, as in the case of outdoors during daytime, when a red mark is captured under sunlight, the red mark may appear yellowish in some cases. Meanwhile, when a blue mark is captured under light of an incandescent lamp indoors, the blue mark may appear blackish. If a mark is captured as a region of a color different from the original color, erroneous detection of a two-dimensional code or erroneous recognition of information could be caused.

Thus, an object of the present disclosure is to provide an image processing device, a computer program, and an image processing system that allow detection of a label including a plurality of color regions without influence of illumination.

### Effect of the Present Disclosure

According to the present disclosure, a label including a plurality of color regions can be detected without being influenced by illumination.

### Outline of Embodiment of the Present Disclosure

First, the outline of embodiments of the present disclosure are listed and described.

(1) An image processing device according to one embodiment of the present disclosure includes: an image acquisition unit configured to acquire a color image captured by a camera; a brightness determination unit configured to determine a brightness in an imaging range of the camera; a detection target color determination unit configured to determine, on the basis of a determination result by the brightness determination unit, detection target colors of two or more colors from among three or more colors provided to a label including regions of the three or more colors; and a label detection unit configured to detect the label by extracting, from the image acquired by the image acquisition unit, regions of the detection target colors determined by the detection target color determination unit.

According to this configuration, detection target colors of two or more colors are determined on the basis of the brightness in the imaging range of the camera, from among colors of a label including regions of three or more colors. Accordingly, the detection target colors can be determined while any color whose appearance changes depending on the brightness is excluded. Thus, by extracting the regions of the detection target colors, it is possible to detect the label without being influenced by illumination.

(2) Preferably, the brightness determination unit determines the brightness on the basis of at least one of the image acquired by the image acquisition unit, imaging parameter information regarding adjustment of a brightness acquired from the camera, and illuminance information acquired from an illuminance sensor configured to measure an illuminance at a position included in the imaging range of the camera.

According to this configuration, the brightness in the imaging range of the camera can be easily determined. In particular, when the brightness is determined on the basis of an image or an imaging parameter, it is not necessary to provide a special device for brightness determination. Thus, the brightness can be determined at low cost.

(3) The detection target color determination unit may determine, as one of the detection target colors, at least an intermediate wavelength color which is a color other than a color having a longest wavelength and a color having a shortest wavelength among the three or more colors.

When it is bright in the imaging range of the camera, a color having a long wavelength is captured as a color different from the original color. When it is dark in the imaging range of the camera, a color having a short wavelength is captured as a color different from the original color. Therefore, an intermediate wavelength color excluding at least these colors is less likely to be influenced by illumination. Thus, according to this configuration, the label can be detected without being influenced by illumination.

(4) The label detection unit may, starting from a region of the intermediate wavelength color, sequentially extract the regions of the detection target colors.

According to this configuration, it is possible to perform region extraction preferentially from the region of the intermediate wavelength color, which is least likely to be influenced by illumination. Therefore, when the region of the intermediate wavelength color cannot be extracted, it is not necessary to extract a region of another detection target color. Thus, the processing time can be shortened.

(5) The label may include a red region, a blue region, and a green region.

Red, blue, and green, which are the three primary colors of light, are colors whose wavelengths are separated from one another to an appropriate extent. Therefore, even when a region of one color is, under influence of illumination, captured as a region of a color different from the original color, the other two colors are captured as regions of original colors, without being influenced by illumination. Thus, by using the other two colors as the detection target colors, the label can be detected without being influenced by illumination.

(6) The image processing device described above may further include an output unit configured to output information according to a detection result by the label detection unit.

According to this configuration, for example, when the label has been detected, it is possible to cause a speaker to output a sound such as an alarm sound or a voice indicating that the label has been detected, or it is possible to cause a display device to display an image of a detection result of the label. Accordingly, the user can be notified of the detection result of the label.

(7) A computer program according to another embodiment of the present disclosure causes a computer to function as: an image acquisition unit configured to acquire a color image captured by a camera; a brightness determination unit configured to determine a brightness in an imaging range of the camera; a detection target color determination unit configured to determine, on the basis of a determination result by the brightness determination unit, detection target colors of two or more colors from among three or more colors provided to a label including regions of the three or more colors; and a label detection unit configured to detect the label by extracting, from the image acquired by the image acquisition unit, regions of the detection target colors determined by the detection target color determination unit.

According to this configuration, a computer can be realized as the image processing device described above. Therefore, actions and effects similar to those of the image processing device described above can be exhibited.

(8) An image processing system according to another embodiment of the present disclosure includes: a label including regions of three or more colors, the label configured to be attached to a detection target object; a camera configured to capture a color image; and the image processing device described above.

This configuration includes the image processing device described above. Therefore, actions and effects similar to those of the image processing device described above can be exhibited.

### DETAILED DESCRIPTION OF EMBODIMENT OF THE PRESENT DISCLOSURE

Hereinafter, embodiments of the present disclosure will be described in detail with reference to the drawings. The embodiments described below are preferable specific examples of the present disclosure. Numeric values, shapes, components, arrangement positions and connection forms of components, steps, the order of steps, and the like indicated in the embodiments below are merely examples, and are not intended to limit the present disclosure. The present disclosure is specified by the claims. Therefore, among the components in the embodiments below, components that are not described in the independent claims, which represent the highest-order concept of the present disclosure, are not necessarily required in order to achieve the problem addressed by the present disclosure, but are described as components for realizing more preferable embodiments.

The same components are denoted by the same reference signs. Since those components have similar functions and names, descriptions thereof are omitted as appropriate.

### Embodiment 1

Hereinafter, an image processing system according to Embodiment 1 is described.

[Configuration of Image Processing System]

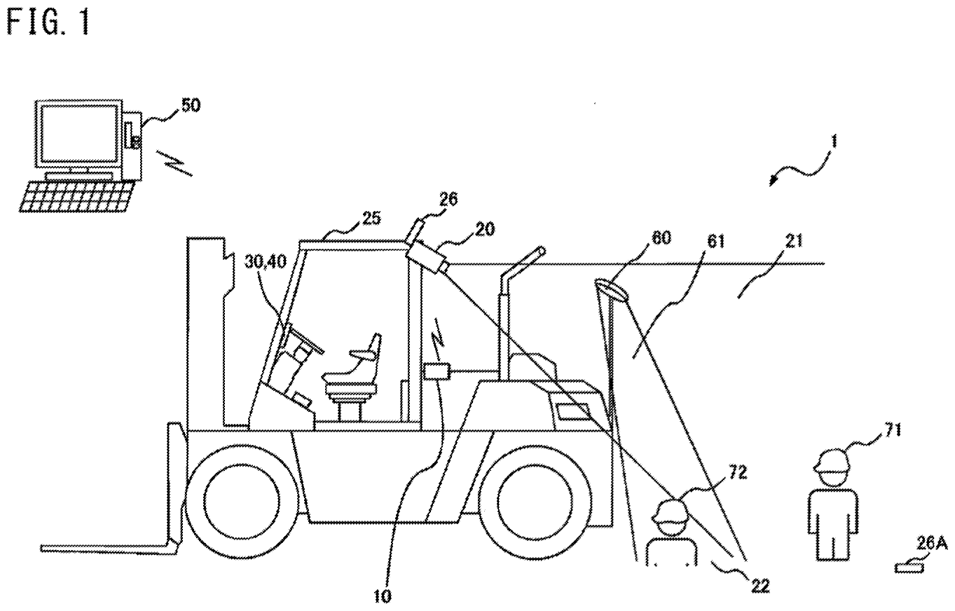

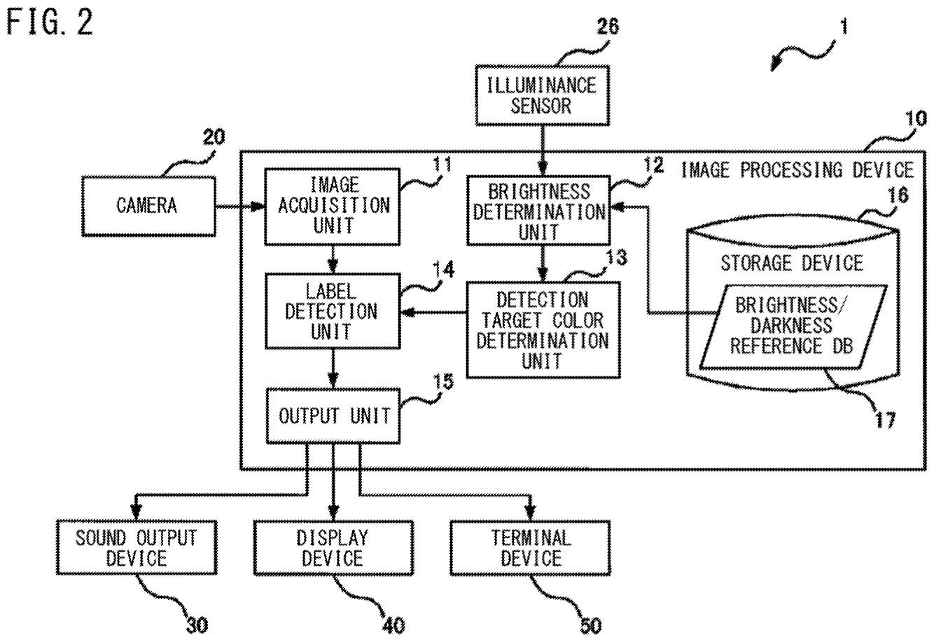

FIG. 1 shows a mounting example of an image processing system according to Embodiment 1. FIG. 2 is a block diagram showing a configuration of the image processing system according to Embodiment 1.

In the following, an image processing system in which a camera and an image processing device are installed in a forklift is described. However, the place to which the camera and the image processing device are installed is not limited to a forklift. For example, these may be mounted to an automobile. In a case where the camera is used for monitoring a predetermined area, the camera may be installed in a place where the camera can capture images of the area.

An image processing system 1 is a system for monitoring the surround of a forklift 25, and includes a camera 20, an illuminance sensor 26, an image processing device 10, a sound output device 30, a display device 40, and a terminal device 50. The configuration of the image processing system 1 shown in FIG. 1 and FIG. 2 is an example, and any one of the sound output device 30, the display device 40, and the terminal device 50 may not necessarily be provided.

For example, the camera 20 is mounted at a position (for example, a rear end position of the overhead guard of the forklift 25) at which the camera 20 can capture images of a place behind the forklift 25, and captures color images of the place behind the forklift 25. The camera lens of the camera 20 is a super-wide-angle lens having a field angle of 120° or greater, for example.

In the place behind the forklift 25, a dead angle region 22 outside an imaging region 21 of the forklift 25 may exist in some cases. In order to cover the dead angle region 22, a mirror 60 is provided in the imaging region 21 of the forklift 25. That is, if the mirror 60 is disposed such that the imaging region 61 when the camera 20 captures an image via the mirror 60 covers the dead angle region 22, the camera 20 can capture an image of a person 72 present in the dead angle region 22. In order to capture an image of the dead angle region 22, another camera different from the camera 20 may be provided, instead of the mirror 60.

The illuminance sensor 26 is a sensor which converts light having entered a light receiving element into an electric current and measures the illuminance. The illuminance sensor 26 is disposed, for example, at a ceiling portion or the like of the forklift 25, and measures the illuminance at a position included in the imaging range of the camera 20. Preferably, the illuminance sensor 26 is provided in the vicinity or in the imaging region 21 of the camera 20. In addition, preferably, the illuminance sensor 26 is mounted in a direction parallel to the optical axis direction of the camera 20 so as to be able to measure the illuminance in the optical axis direction of the camera 20.

The illuminance sensor 26 may not necessarily be installed to the forklift 25. For example, an illuminance sensor 26A may be installed in advance in a range where the forklift 25 can travel. That is, the illuminance sensor 26A may be installed on a traveling path of the forklift 25 or in the vicinity of the traveling path. Here, the illuminance sensor 26A is a sensor that measures the illuminance in the surround, similar to the illuminance sensor 26.

It is preferable that the measurement range of illuminance by the illuminance sensor 26 or 26A is included in the imaging range of the camera 20. However, the measurement range and the imaging range may be slightly shifted from each other, if the shifted distance is about a several meters. Since the illuminance is not likely to significantly change due to a small positional shift, it is considered that a positional shift to this extent does not influence the result of image processing.

The image processing device 10 is a computer installed in the forklift 25. The image processing device 10 is connected to the camera 20 and detects persons 71 and 72 from an image of the imaging regions 21 and 61 captured by the camera 20. In the present embodiment, it is assumed that a label in which regions of predetermined three or more colors are arranged in a predetermined positional relationship is attached to each of the persons 71 and 72 without fail.

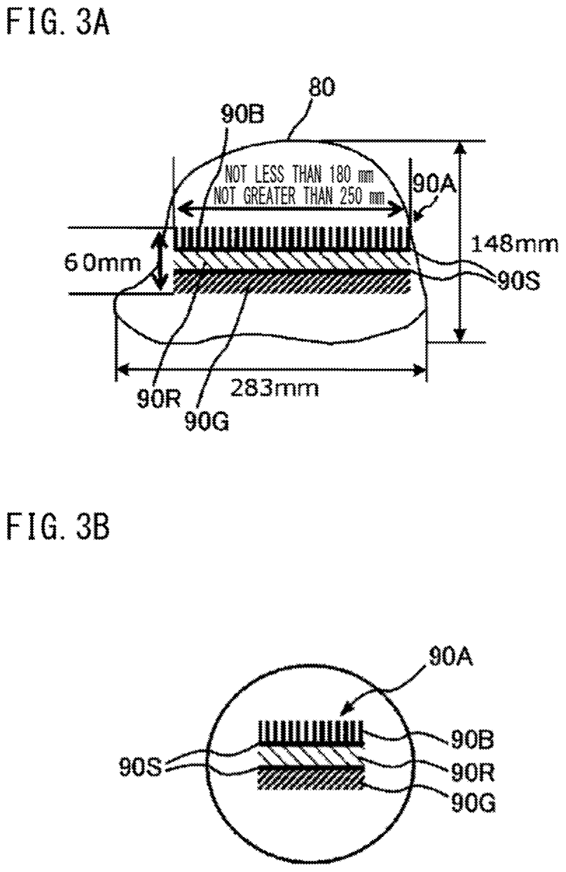

FIG. 3A shows a helmet worn by a person, viewed sideways. FIG. 3B shows the helmet viewed from above.

As shown in FIG. 3A and FIG. 3B, a helmet 80 has a label 90A attached thereto. The label 90A is formed by a blue label 90B, a red label 90R, and a green label 90G which are arranged in parallel to one another. As shown in FIG. 3A, when the helmet 80 has a width of 283 mm and a height of 148 mm, the label 90A can have a width of about 60 mm and a length of not less than about 180 mm and not greater than 250 mm.

A gap region 90S is provided between the blue label 90B and the red label 90R, and between the red label 90R and the green label 90G. The gap region 90S is a black region, for example, and has a width of 2 to 3 mm. Since the gap region 90S is provided, even when a disturbance of an image captured by the camera 20 is occurring due to vibration and the like during travelling of the forklift 25, an image in which the color of a color label is mixed with the color of a color label adjacent thereto is prevented from being captured.

As shown in FIG. 3B, the label 90A is also attached to an upper part of the helmet 80. In addition, the label 90A is also attached to the side face on the opposite side, the front face, and the rear face of the helmet 80. Since the label 90A is attached to various places in this manner, even if a person takes any attitude (standing, squatting, etc.), an image of any one of the labels 90A can be captured by the camera 20.

The label 90A is formed by the red label 90R, the green label 90G, and the blue label 90B, which are labels of the three primary colors of light.

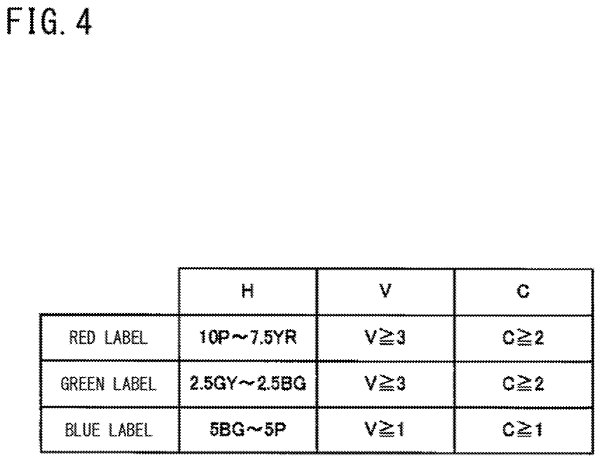

FIG. 4 shows expressions according to the Munsell color system (JISZ8721) of the respective color labels.

In FIG. 4, H, V, and C represent hue, value, and chroma according to the Munsell color system, respectively. That is, as for the color of the red label 90R, the hue (H) is included in a range of 10P to 7.5YR, the value (V) is not less than 3, and the chroma (C) is not less than 2, each according to the Munsell color system. As for the color of the green label 90G, the hue (H) is included in a range of 2.5GY to 2.5BG, the value (V) is not less than 3, and the chroma (C) is not less than 2, each according to the Munsell color system. As for the color of the blue label 90B, the hue (H) is included in a range of 5BG to 5P, the value (V) is not less than 1, and the chroma (C) is not less than 1, each according to the Munsell color system. However, the label 90A is not limited to a label that is formed as a label of the three primary colors of light, and may be formed as a label of colors other than the three primary colors of light.

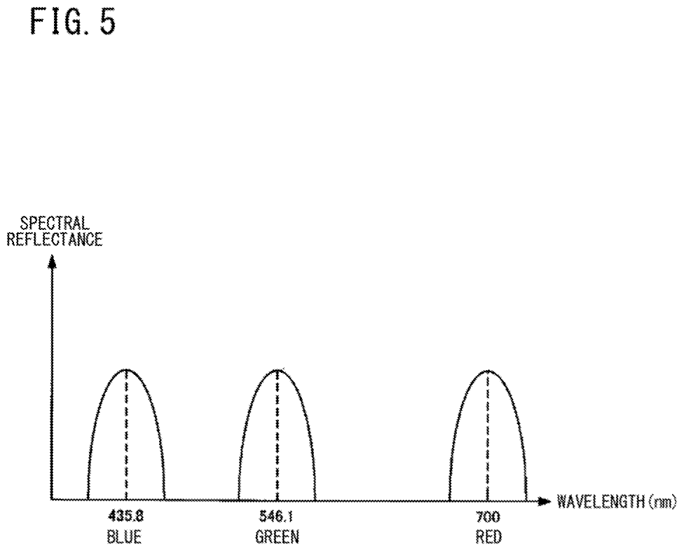

FIG. 5 shows the spectral reflectance of each color label. The horizontal axis represents wavelength (nm) and the vertical axis represents spectral reflectance (%).

As shown in FIG. 5, red exhibited by the red label 90R has a peak of spectral reflectance near a wavelength of 700 nm. The green exhibited by the green label 90G has a peak of spectral reflectance near a wavelength of 546.1 nm. Blue exhibited by the blue label 90B has a peak of spectral reflectance near a wavelength of 435.8 nm. The peaks of spectral reflectance of the respective colors are not limited to the values described above. For example, red only needs to have a peak of spectral reflectance at a wavelength of 700±30 nm. Green only needs to have a peak of spectral reflectance at a wavelength of 546.1±30 nm. Blue only needs to have a peak of spectral reflectance at a wavelength of 435.8±30 nm.

In addition, preferably, the blue label 90B, the red label 90R, and the green label 90G are each implemented as a fluorescent tape, or these labels each have a fluorescent paint applied thereto. Accordingly, even in an environment where illuminance is low such as during night time or a cloudy day, the label can be easily recognized. In addition, the label can be recognized without using a special camera such as an infrared camera.

With reference to FIG. 1, the image processing device 10 detects the label 90A from an image captured by the camera 20, thereby detecting a person. The detailed configuration of the image processing device 10 will be described later.

The sound output device 30 is installed near the driver's seat of the forklift 25, and includes a speaker, for example. The sound output device 30 is connected to the image processing device 10, and outputs a notification sound such as an alarm sound or a message voice notifying a driver that the image processing device 10 has detected the person 71 or the person 72.

For example, the display device 40 is installed at a position where the display device 40 can be viewed by the driver of the forklift 25, and includes a liquid crystal display or the like. The display device 40 is connected to the image processing device 10 and displays an image that makes a notification that the image processing device 10 has detected the person 71 or the person 72.

The terminal device 50 is a computer installed at a distant place from the forklift 25, such as a control room for controlling the forklift 25, for example. The terminal device 50 is connected to the image processing device 10. The terminal device 50 outputs an image or a sound that makes a notification that the image processing device 10 has detected the person 71 or the person 72, and records the detection of the person 71 or the person 72 as log information, together with time information. The terminal device 50 and the image processing device 10 may be connected to each other by a mobile phone line according to a communication standard such as 4G, or by a wireless LAN (Local Area Network) such as Wi-Fi (registered trade mark).

The terminal device 50 may be a smartphone carried by the person 71 or 72. Accordingly, the person 71 or 72 can be notified that the person 71 or 72 himself or herself has been detected by the image processing device 10, i.e., that the forklift 25 is present nearby.

The functions of the image processing device 10, the camera 20, the sound output device 30, and the display device 40 may be provided in a smartphone, a computer equipped with a camera, or the like. For example, a smartphone is mounted at the position of the camera 20 shown in FIG. 1, and the smartphone processes an image captured by the smartphone, and detects the persons 71 and 72. In addition, the smartphone makes a notification of a detection result by means of a sound or an image. However, in a case where the smartphone is mounted at the position of the camera 20, the driver cannot see the image. Therefore, another tablet device or the like is installed at a position where the tablet device can be viewed by the driver, and the tablet device may display an image transmitted from the smartphone. The tablet device and the smartphone may be wirelessly connected to each other in accordance with a wireless communication standard such as Wi-Fi (registered trade mark), Bluetooth (registered trade mark), or Zigbee (registered trade mark), for example.

[Change in Appearance of Color of Label Due to Illumination Environment]

Next, a phenomenon in which the appearances of the colors of the label 90A change due to illumination environments is described.

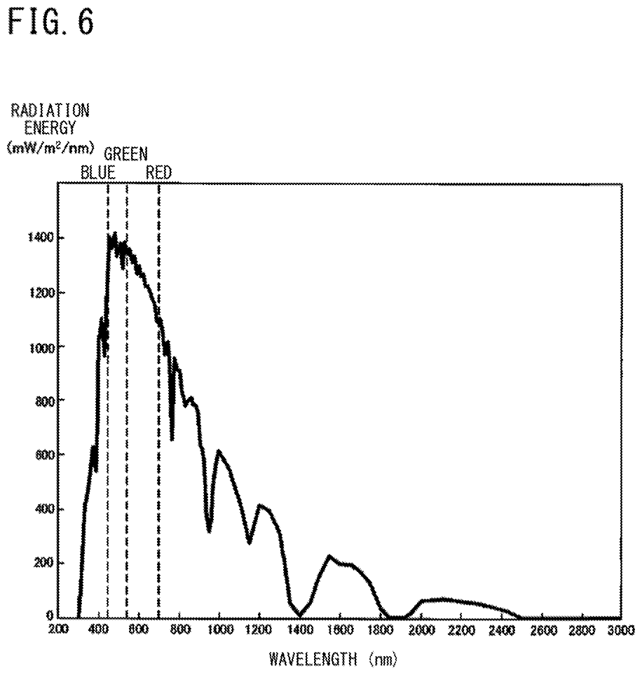

FIG. 6 shows a spectral distribution of sunlight. The horizontal axis represents wavelength and the vertical axis represents radiation energy.

When components of red, green, and blue light included in sunlight are compared, components of red light are fewer than components of green and blue light. Therefore, when the camera 20 captures a red region outdoors where the light source is the sun, light of red components received by the camera 20 is relatively weak. Thus, on an image, the red region may appear as a yellow region in some cases.

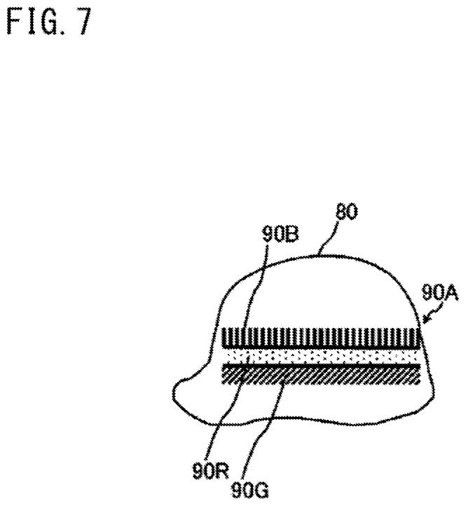

FIG. 7 is a schematic diagram showing a label captured in a bright environment under sunlight. The label 90A shown in FIG. 7 is the same as the label 90A shown in FIG. 3A. However, due to the influence of sunlight, the intensity of light of red components is weak. This causes the red label 90R to appear as a yellowish label on an image.

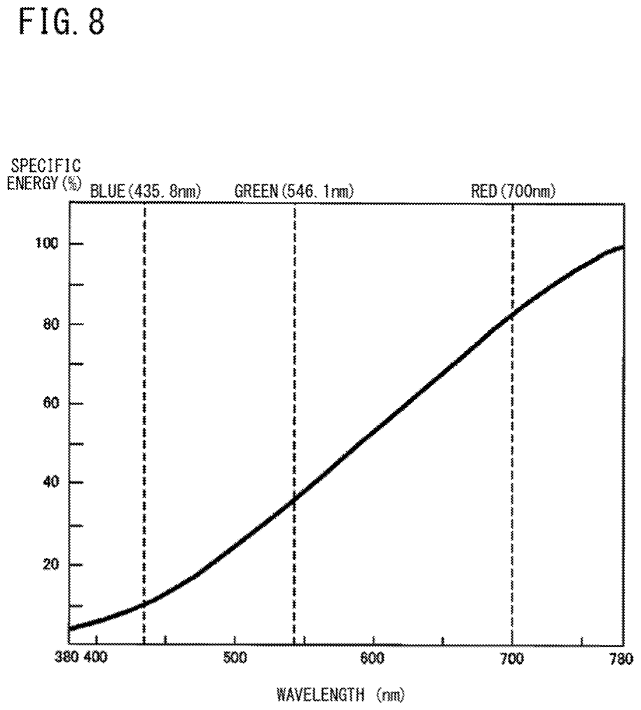

FIG. 8 shows a spectral distribution of light of an incandescent lamp. The horizontal axis represents wavelength and the vertical axis represents specific energy. The specific energy represents relative intensity when it is assumed that the maximum value of light emission intensity in a measured wavelength range is 100%.

When components of red, green, and blue light included in light of an incandescent lamp are compared, the blue components are fewer than the red and green components. Therefore, when the camera 20 captures a blue region indoors where the light source is an incandescent lamp, light of blue components received by the camera 20 is relatively weak. Thus, on an image, the blue region may appear as a black region in some cases.

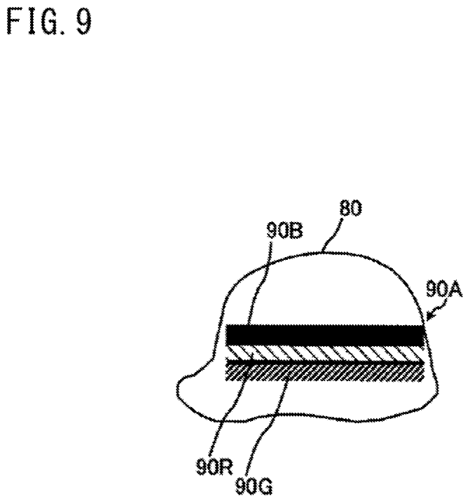

FIG. 9 is a schematic diagram showing a label captured in a dark environment under light of an incandescent lamp. The label 90A shown in FIG. 9 is the same as the label 90A shown in FIG. 3A. However, due to influence of the light of an incandescent lamp, the intensity of light of blue components is weak. This causes the blue label 90B to appear as a black label on an image.

The illumination used in a dark environment is not limited to an incandescent lamp, and may be an electric bulb of another color, a fluorescent lamp, an LED (Light Emitting Diode) illumination, or the like.

As described above, the appearance of the color of each color label may change due to influence of illumination. In the present embodiment, the image processing device 10 that can detect the label 90A without being influenced by illumination is described below.

[Configuration of Image Processing Device 10]

With reference to FIG. 2, functional components of the image processing device 10 are described further in detail.

The image processing device 10 is implemented as a general computer that includes a CPU (Central Processing Unit), a RAM (Random Access Memory), a ROM (Read Only Memory), a HDD (Hard Disk Drive), a communication I/F (interface), a timer, and the like. The image processing device 10 includes an image acquisition unit 11, a brightness determination unit 12, a detection target color determination unit 13, a label detection unit 14, and an output unit 15, which are functional components realized by executing a computer program read out from the HDD or the ROM into the RAM. In addition, the image processing device 10 includes a storage device 16.

The image acquisition unit 11 acquires, via a communication I/F, a color image captured by the camera 20. That is, the image acquisition unit 11 acquires an image, of the imaging regions 21 and 61 shown in FIG. 1, captured by the camera 20.

The brightness determination unit 12 determines the brightness in the imaging range of the camera 20. That is, on the basis of illuminance information, of the imaging range of the camera 20, measured by the illuminance sensor 26, the brightness determination unit 12 refers to a brightness/darkness reference DB (database) stored in the storage device 16 described later, and determines whether the imaging range of the camera 20 corresponds to a bright environment, a dark environment, or a medium-brightness environment.

In a case where the brightness determination unit 12 acquires illuminance information from the illuminance sensor 26A installed at a place other than the forklift 25, illuminance information may be directly received from the illuminance sensor 26A through wireless communication, or illuminance information may be received from the illuminance sensor 26A via the terminal device 50. At that time, the brightness determination unit 12 specifies the illuminance sensor 26A included in the imaging range of the camera 20 on the basis of the position of the forklift 25 and camera parameters (optical axis direction, zooming magnification, etc.) of the camera 20, and acquires illuminance information from the specified illuminance sensor 26A. If the brightness determination unit 12 can acquire position information together with illuminance information from the illuminance sensor 26A, the brightness determination unit 12 may specify the illuminance sensor 26A included in the imaging range of the camera 20 by comparing the position of the forklift 25 with the position of the illuminance sensor 26A indicated by the acquired position information.

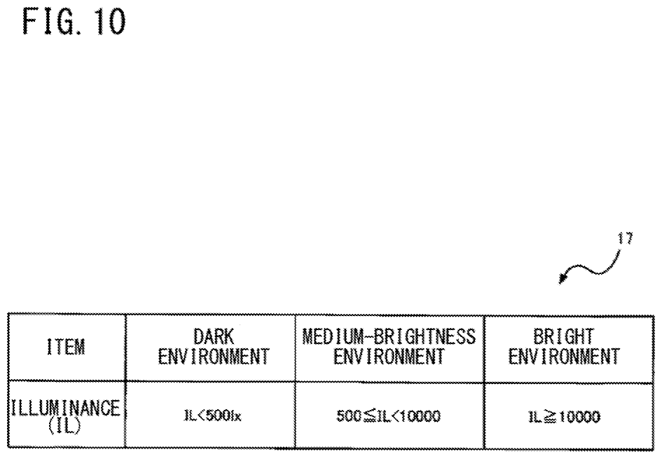

FIG. 10 shows one example of a brightness/darkness reference DB 17. The brightness/darkness reference DB 17 shows a reference for determining, on the basis of an illuminance (IL), whether the environment having the illuminance is a bright environment, a dark environment, or a medium-brightness environment. For example, according to the brightness/darkness reference DB 17 shown in FIG. 10, an environment having an illuminance of IL<500 lx is a dark environment. An environment having an illuminance of 500≤IL<10000 is a medium-brightness environment. An environment having an illuminance of IL≥10000 is a bright environment.

That is, when the illuminance IL measured by the illuminance sensor 26 is IL<500 lx, the brightness determination unit 12 determines that the imaging range of the camera 20 corresponds to a dark environment. When the illuminance IL measured by the illuminance sensor 26 is 500≤IL<10000, the brightness determination unit 12 determines that the imaging range of the camera 20 corresponds to a medium-brightness environment. Further, when the illuminance IL measured by the illuminance sensor 26 is IL≥10000, the brightness determination unit 12 determines that the imaging range of the camera 20 corresponds to a bright environment.

The detection target color determination unit 13 determines detection target colors of two or more colors from among three colors applied to the label 90A, on the basis of a determination result by the brightness determination unit 12. That is, the detection target color determination unit 13 determines, as the detection target colors, colors excluding any color whose appearance changes depending on the illumination environment.

Specifically, in a bright environment, the red region may appear as a yellow region in an image. Thus, when the brightness determination unit 12 has determined that the environment is a bright environment, the detection target color determination unit 13 determines the two colors of green and blue excluding red, as the detection target colors.

In a dark environment, the blue region may appear as a black region in an image. Thus, when the brightness determination unit 12 has determined that the environment is a dark environment, the detection target color determination unit 13 determines the two colors of red and green excluding blue, as the detection target colors.

However, the dark environment here means an environment under light of an incandescent lamp. Thus, under another artificial light source such as a fluorescent lamp or LED illumination, the color whose appearance changes is not necessarily blue. Therefore, in a case where the artificial light source other than an incandescent lamp is used, the detection target color determination unit 13 determines, as the detection target colors, colors with any color whose appearance changes being excluded according to the kind of the artificial light source.

It is considered that, when the red region, the green region, and the blue region are captured by the camera 20 in a medium-brightness environment, there is no big difference in the intensity of light received by the camera 20 among the respective regions. Therefore, when the brightness determination unit 12 has determined that the environment is a medium-brightness environment, the detection target color determination unit 13 determines the three colors of red, green, and blue, as the detection target colors.

The label detection unit 14 detects the label 90A by extracting the regions of the detection target colors determined by the detection target color determination unit 13 from the image acquired by the image acquisition unit 11.

Specifically, on the basis of a predetermined threshold and a pixel value in a color space of each pixel forming the image acquired by the image acquisition unit 11, the label detection unit 14 extracts a region of each detection target color. Here, the HSV color space is assumed as the color space. In addition, hue (H), saturation (S), and value (V) are assumed as pixel values in the HSV color space.

In a case where the image acquired by the image acquisition unit 11 is composed of pixel values in the RGB color space, the label detection unit 14 converts the pixel values in the RGB color space into pixel values in the HSV color space, and then, performs a region extraction process. The conversion of a pixel value in the RGB color space into a pixel value in the HSV color space is performed according to Formula 1 to Formula 3 bellow, for example.

$$\begin{matrix}[ Math . 1 ] & \\ H = \{ \begin{matrix}60 \times \frac{G - B}{MAX - MIN} & if MAX = R \\ 60 \times \frac{B - R}{MAX - MIN} + 120 & if MAX = G \\ 60 \times \frac{R - G}{MAX - MIN} + 240 & if MAX = B\end{matrix} & ( Formula 1 ) \\ S = \frac{MAX - MIN}{MAX} & ( Formula 2 ) \\ V = MAX & ( Formula 3 )\end{matrix}$$

Here, R, G, and B respectively represent a red component, a green component, and a blue component of a pixel before conversion. MAX and MIN respectively represent a maximum value and a minimum value of the red component, the green component, and the blue component of the pixel before conversion.

It is assumed that, in the label detection unit 14, not less than 95 and not greater than 145 is set as the range of hue (H) of green, not less than 70 and not greater than 100 is set at the range of saturation (S) of green, and not less than 70 and not greater than 100 is set as the range of value (V) of green, for example. In a case where green is the detection target color, when a pixel has a hue (H) of not less than 95 and not greater than 145, a saturation (S) of not less than 70 and not greater than 100, and a value (V) of not less than 70 and not greater than 100, the label detection unit 14 extracts the pixel as a green pixel.

It is assumed that, in the label detection unit 14, ranges of hue (H), saturation (S), and value (V) of red, and ranges of hue (H), saturation (S), and value (V) of blue are set in a similar manner. In a case where red is the detection target color, the label detection unit 14 extracts a red pixel from the image using the ranges of hue (H), saturation (S), and value (V) of red. In a case where blue is the detection target color, the label detection unit 14 extracts a blue pixel from the image using the ranges of hue (H), saturation (S), and value (V) of blue.

The label detection unit 14 performs a labeling process onto each green pixel, red pixel, or blue pixel which is a pixel of the detection target color, and extracts a green region, a red region, or a blue region by specifying, as one region, pixels that have been provided with an identical label (sign) through the labeling process. The label detection unit 14 may remove a noise region by performing an expansion/contraction process or a filtering process according to the region size, onto each of the extracted green region, red region, or blue region.

When the extracted regions of the detection target colors have a predetermined positional relationship, the label detection unit 14 determines that the regions of the detection target colors are included in the image acquired by the image acquisition unit 11. For example, in a case where the detection target colors are red, green, and blue, when, on an image, a red region is present in a predetermined distance range from the centroid position of a green region and a blue region is present in a predetermined distance range from the centroid position of the red region, the label detection unit 14 determines that the green region, the red region, and the blue region are included in the image. When the label detection unit 14 has determined that the region of the detection target color is included in the image, the label detection unit 14 considers that the label 90A has been detected in the image. Thus, the label detection unit 14 can determine that a person is present in the surround of the forklift 25.

The label detection unit 14 may change the ranges of hue (H), saturation (S), and value (V) of each color in accordance with a determination result by the brightness determination unit 12. If the range is changed in accordance with the brightness in the imaging range of the camera 20, the label detection unit 14 can more accurately extract a region.

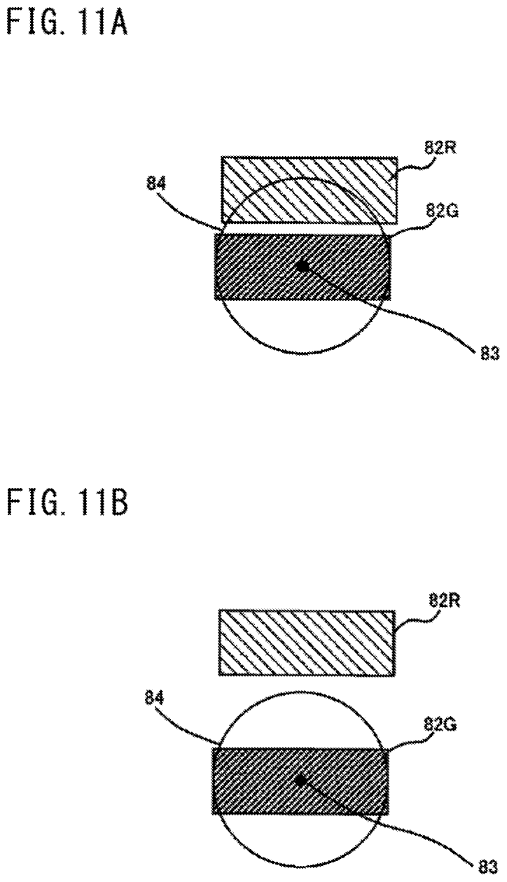

FIG. 11A and FIG. 11B each show one example of a green region and a red region on an image. As shown in FIG. 11A, when a red region 82R is included in a predetermined distance range 84 indicated by a circle about a centroid position 83 of a green region 82G, it is determined that the red region 82R is present in the predetermined distance range 84 from the centroid position 83 of the green region 82G on the image.

Meanwhile, as shown in FIG. 11B, when the red region 82R is not included in the predetermined distance range 84 indicated by the circle about the centroid position 83 of the green region 82G, it is determined that the red region 82R is not present in the predetermined distance range 84 from the centroid position 83 of the green region 82G on the image.

Here, the diameter of the circle indicating the predetermined distance range 84 may be the length of the longest side of the green region 82G, for example. When the green region 82G has a shape other than an rectangle, the length of the longest side of a circumscribing rectangle of the green region 82G may be set as the diameter of the circle indicating the predetermined distance range 84. The diameter may be a value other than these.

Even in a case where the combination of the detection target colors is not a combination of red, green, and blue, the label detection unit 14 determines, through a similar process, whether or not the extracted regions of the detection target colors have a predetermined positional relationship.

The output unit 15 outputs information according to a detection result by the label detection unit 14. For example, when the label detection unit 14 has detected the label 90A, the output unit 15 transmits, via a communication I/F, a predetermined sound signal to the sound output device 30, thereby causing the sound output device 30 to output a notification sound. Accordingly, the driver is notified that a person is present in the surround of the forklift 25.

When the label detection unit 14 has detected the label 90A, the output unit 15 transmits, via a communication I/F, a predetermined image signal to the display device 40, thereby causing the display device 40 to display an image for making a notification that a person has been detected. Accordingly, the driver is notified that a person is present in the surround of the forklift 25.

When the label detection unit 14 has detected the label 90A, the output unit 15 transmits, to the terminal device 50 via a communication I/F, information indicating that a person has been detected, thereby causing the terminal device 50 to perform a sound or image outputting process or to perform a log information recording process. In that case, the output unit 15 may transmit information of the detection time.

The storage device 16 is a storage device for storing various kinds of information including the brightness/darkness reference DB 17, and is implemented by a magnetic disk, a semiconductor memory, or the like.

[Process Flow of Image Processing Device 10]

Next, a flow of processes performed by the image processing device 10 is described.

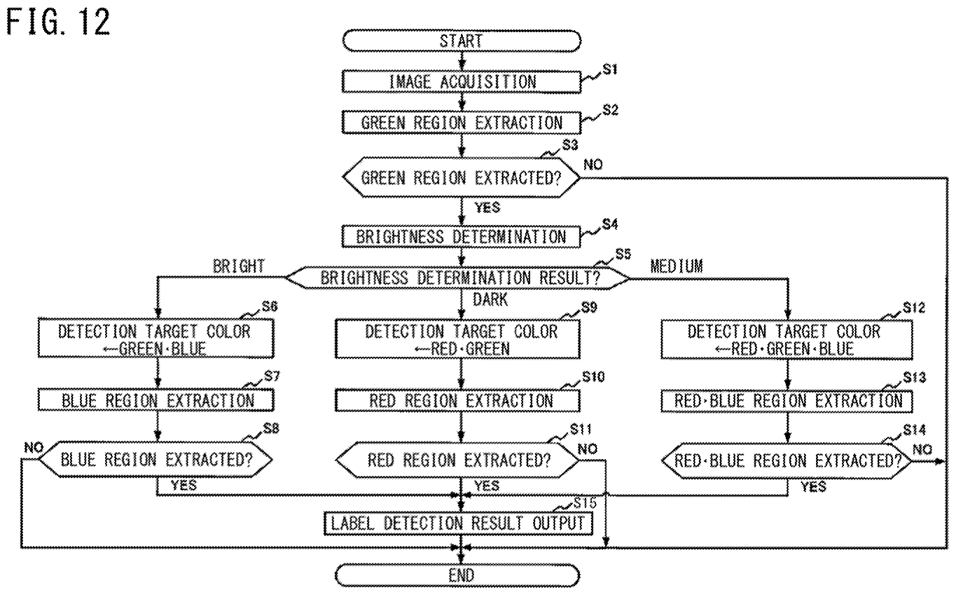

FIG. 12 is a flow chart showing a procedure of processes performed by the image processing device 10 according to Embodiment 1.

With reference to FIG. 12, the image acquisition unit 11 acquires an image captured by the camera 20 (S1).

The label detection unit 14 extracts a green region from the image acquired by the image acquisition unit 11 (S2). Since the green region can be extracted without being influenced by the illumination environment, green serves as an essential detection target color. Therefore, the extraction process of the green region is performed, without a detection target color determination process (steps S6, S9, and S12 described later) being performed by the detection target color determination unit 13.

When the green region has not been extracted (NO in S3), it is possible to determine that the label 90A is not included in the image. Thus, the image processing device 10 ends the process.

When the green region has been extracted (YES in S3), the brightness determination unit 12 refers to the brightness/darkness reference DB 17 on the basis of the illuminance, in the imaging range of the camera 20, measured by the illuminance sensor 26, and performs a brightness determination process for determining whether the imaging range of the camera 20 corresponds to a bright environment, a dark environment, or a medium-brightness environment (S4).

As a result of the brightness determination process (step S4), when it has been determined that the imaging range of the camera 20 corresponds to a bright environment (bright in S5), the detection target color determination unit 13 determines green and blue as the detection target colors (S6).

The label detection unit 14 extracts a blue region which is a detection target color region not having been extracted (S7).

The label detection unit 14 determines whether or not a blue region having a predetermined positional relationship with the green region has been extracted from the image (S8).

When the blue region having the predetermined positional relationship has not been extracted (NO in S8), it is possible to determine that the label 90A is not included in the image. Thus, the image processing device 10 ends the process.

When the blue region having the predetermined positional relationship has been extracted (YES in S8), the label detection unit 14 detects the green region and the blue region as the label 90A, and the output unit 15 outputs a detection result of the label 90A (S15). For example, the output unit 15 transmits a predetermined sound signal to the sound output device 30, thereby causing the sound output device 30 to output a notification sound.

As a result of the brightness determination process (step S4), when it has been determined that the imaging range of the camera 20 corresponds to a dark environment (dark in S5), the detection target color determination unit 13 determines red and green as the detection target colors (S9).

The label detection unit 14 extracts a red region which is a detection target color region not having been extracted (S10).

The label detection unit 14 determines whether or not a red region having a predetermined positional relationship with the green region has been extracted from the image (S11).

When the red region having the predetermined positional relationship has not been extracted (NO in S11), it is possible to determine that the label 90A is not included in the image. Thus, the image processing device 10 ends the process.

When the red region having the predetermined positional relationship has been extracted (YES in S11), the label detection unit 14 detects the red region and the green region as the label 90A, and the output unit 15 outputs a detection result of the label 90A (S15).

As a result of the brightness determination process (step S4), when it has been determined that the imaging range of the camera 20 corresponds to a medium-brightness environment (medium in S5), the detection target color determination unit 13 determines red, green, and blue as the detection target colors (S12).

The label detection unit 14 extracts a red region and a blue region which are detection target color regions not having been extracted (S13).

The label detection unit 14 determines whether or not a red region and a blue region each having a predetermined positional relationship with the green region have been extracted from the image (S14).

When the red region and the blue region each having the predetermined positional relationship have not been extracted (NO in S14), it is possible to determine that the label 90A is not included in the image. Thus, the image processing device 10 ends the process.

When the red region and the blue region each having the predetermined positional relationship have been extracted (YES in S14), the label detection unit 14 detects the red region, the green region, and the blue region as the label 90A, and the output unit 15 outputs a detection result of the label 90A (S15).

In step S14, if at least one of the red region and the blue region has a predetermined positional relationship with the green region, the label 90A may be determined as being included in the image.

The label detection result outputting process (step S15) may be performed also when the label 90A has not been detected. That is, the output unit 15 may cause the sound output device 30 to output a notification sound indicating that the label 90A has not been detected, or may cause the display device 40 to display an image indicating that the label 90A has not been detected. The output unit 15 may transmit, to the terminal device 50, information indicating that the label 90A has not been detected.

The image processing device 10 repeats the processes shown in FIG. 12 in a predetermined cycle (for example, an interval of 100 msec). Accordingly, the label 90A can be detected in real time.

### Effect of Embodiment 1

As described above, according to Embodiment 1 of the present disclosure, the detection target color determination unit 13 determines detection target colors of two or more colors on the basis of the brightness in the imaging range of the camera 20 from among the colors of the label 90A including regions of three or more colors. Accordingly, detection target colors can be determined while any color whose appearance changes depending on the brightness is excluded. Thus, by the label detection unit 14 extracting the regions of the detection target colors, it is possible to detect the label without being influenced by illumination.

The brightness determination unit 12 can determine the brightness in the imaging range of the camera 20 on the basis of the illuminance, in the imaging range of the camera 20, measured by the illuminance sensor 26. Thus, the brightness in the imaging range of the camera 20 can be easily determined.

Irrespective of the illumination environment, the detection target color determination unit 13 determines green, as an essential detection target color, which is, among red, green, and blue, a color that has an intermediate wavelength and that is other than red having the longest wavelength and blue having the shortest wavelength. Since green is a color less likely to be influenced by illumination, the label detection unit 14 can detect the label 90A without being influenced by illumination.

The label detection unit 14 performs the region extraction process preferentially from the region of green which is an intermediate wavelength color and which is the essential detection target color (S2 in FIG. 12). Therefore, when the green region has not been extracted, the label detection unit 14 need not extract a red region or a blue region which is another detection target color. Thus, the processing time can be shorted.

The label 90A is formed by the red label 90R, the green label 90G, and the blue label 90B. Red, blue, and green, which are the three primary colors of light, are colors whose wavelengths are separated from one another to an appropriate extent. Therefore, even when a region of either one of the colors (red or blue) is, under influence by illumination, captured as a region of a color different from the original color, the other two colors including green as the intermediate wavelength color are captured as regions of original colors, without being influenced by the illumination. Thus, by using the other two colors as the detection target colors, the label can be detected without being influenced by illumination.

When the label detection unit 14 has detected the label 90A, the output unit 15 can cause the sound output device 30 to output a sound such as an alarm sound or a voice indicating that the label 90A has been detected, or can cause the display device 40 to display an image indicating the detection result of the label 90A. In addition, the output unit 15 can transmit, to the terminal device 50, information indicating the detection result of the label 90A. Accordingly, the user can be notified of the detection result of the label 90A.

### Embodiment 2

In Embodiment 1, the label is formed by the blue label 90B, the red label 90R, and the green label 90G. However, the colors of the labels are not limited thereto. In Embodiment 2, an example using a label formed by color labels of four colors is described.

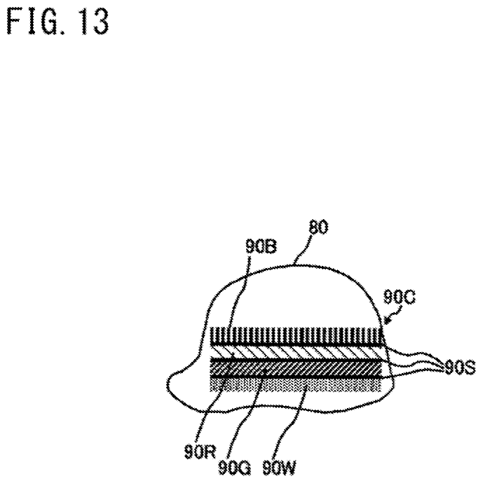

FIG. 13 shows one example of a label attached to a helmet. As shown in FIG. 13, the helmet 80 has a label 90C attached thereto. The label 90C is formed by the blue label 90B, the red label 90R, the green label 90G, and a white label 90W which are arranged in parallel to one another. The gap region 90S is provided between the blue label 90B and the red label 90R, between the red label 90R and the green label 90G, and between the green label 90G and the white label 90W.

White is an achromatic color whose saturation is 0, and includes various wavelengths. Thus, the white label 90W is a label that can be detected without being influenced by brightness.

Since white is an achromatic color, when the label detection unit 14 extracts white pixels in an image, saturation (S) and value (V) of each pixel are compared with the respective ranges, but hue (H) is not compared with the range thereof. Accordingly, from an image, the label detection unit 14 extracts, as white pixels, pixels that each have a saturation (S) and a value (V) respectively exceeding the saturation range and the value range of white, and performs a labeling process on the extracted white pixels, thereby extracting a white region.

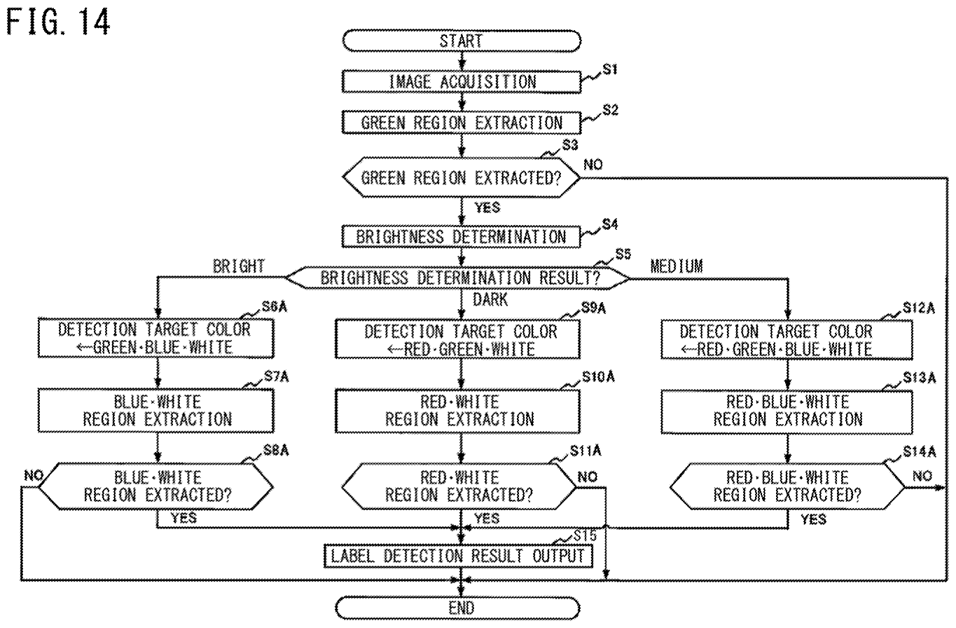

The configuration of the image processing device according to Embodiment 2 is similar to that shown in FIG. 2. However, processes performed by the detection target color determination unit 13 and the label detection unit 14 are partially different. In the following, with reference to the flow chart shown in FIG. 14, processes different from those in Embodiment 1 are described.

FIG. 14 is a flow chart showing a procedure of processes performed by the image processing device 10 according to Embodiment 2.

The image processing device 10 performs the processes of step S1 to S4. The processes of step S1 to S4 are the same as those shown in FIG. 12.

As a result of the brightness determination process (step S4), when it has been determined that the imaging range of the camera 20 corresponds to a bright environment (bright in S5), the detection target color determination unit 13 determines green, blue, and white as the detection target colors (S6A).

The label detection unit 14 extracts a blue region and a white region which are detection target color regions not having been extracted (S7A).

The label detection unit 14 determines whether or not a blue region and a white region each having a predetermined positional relationship with the green region have been extracted from the image (S8A).

When the blue region and the white region each having the predetermined positional relationship have not been extracted (NO in S8A), it is possible to determine that the label 90C is not included in the image. Thus, the image processing device 10 ends the process.

When the blue region and the white region each having the predetermined positional relationship have been extracted (YES in S8A), the label detection unit 14 detects the green region, the blue region, and the white region as the label 90C, and the output unit 15 outputs a detection result of the label 90C (S15).

As a result of the brightness determination process (step S4), when it has been determined that the imaging range of the camera 20 corresponds to a dark environment (dark in S5), the detection target color determination unit 13 determines red, green, and white as the detection target colors (S9A).

The label detection unit 14 extracts a red region and a white region which are detection target color regions not having been extracted (S10A).

The label detection unit 14 determines whether or not a red region and a white region each having a predetermined positional relationship with the green region have been extracted from the image (S11A).

When the red region and the white region each having the predetermined positional relationship have not been extracted (NO in S11A), it is possible to determine that the label 90C is not included in the image. Thus, the image processing device 10 ends the process.

When the red region and the white region each having the predetermined positional relationship have been extracted (YES in S11A), the label detection unit 14 detects the red region, the green region, and the white region as the label 90C, and the output unit 15 outputs a detection result of the label 90C (S15).

As a result of the brightness determination process (step S4), when it has been determined that the imaging range of the camera 20 corresponds to a medium-brightness environment (medium in S5), the detection target color determination unit 13 determines red, green, blue, and white as the detection target colors (S12A).

The label detection unit 14 extracts a red region, a blue region, and a white region which are detection target color regions not having been extracted (S13A).

The label detection unit 14 determines whether or not a red region, a blue region, and a white region each having a predetermined positional relationship with the green region have been extracted from the image (S14A).

When the red region, the blue region, and the white region each having the predetermined positional relationship have not been extracted (NO in S14A), it is possible to determine that the label 90C is not included in the image. Thus, the image processing device 10 ends the process.

When the red region, the blue region, and the white region each having the predetermined positional relationship have been extracted (YES in S14A), the label detection unit 14 detects the red region, the green region, the blue region, and the white region as the label 90C, and the output unit 15 outputs a detection result of the label 90C (S15).

The image processing device 10 repeats the processes shown in FIG. 14 in a predetermined cycle (for example, an interval of 100 msec). Accordingly, the label 90C can be detected in real time.

According to Embodiment 2 of the present disclosure, label detection can be performed using color labels of more colors than in Embodiment 1. Therefore, the label can be detected further without being influenced by illumination. The colors of the color labels included in the label are not limited to those described above. For example, a black label may be used instead of the white label 90W.

### Modification of Embodiment 2

In the present modification, similar to Embodiment 2, it is assumed that the label is formed by color labels of four colors. However, the procedure of the processes performed by the image processing device 10 is different from that in Embodiment 2.

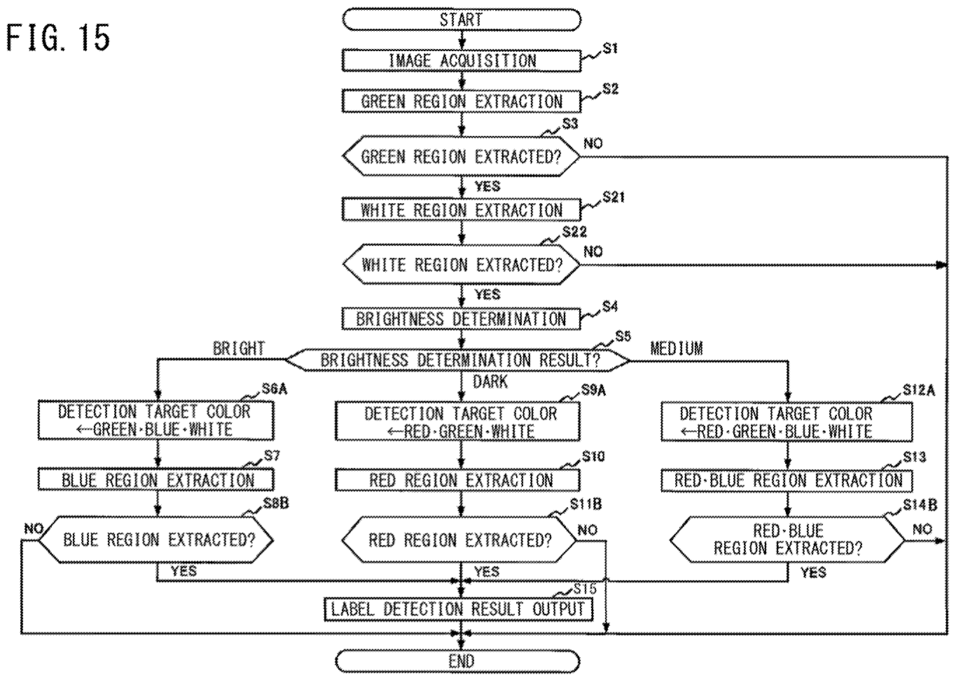

FIG. 15 is a flow chart showing a procedure of processes performed by the image processing device 10 according to a modification of Embodiment 2.

The image processing device 10 performs the processes of step S1 to S3. The processes of step S1 to S3 are the same as those shown in FIG. 12.

When a green region has been extracted (YES in S3), the label detection unit 14 extracts a white region from the image acquired by the image acquisition unit 11 (S21). Since a white region can be extracted without being influenced by the illumination environment, white serves as an essential detection target color. Therefore, the extraction process of the white region is performed, without a detection target color determination process (steps S6A, S9A, and S12A described later) being performed by the detection target color determination unit 13.

When the white region has not been extracted (NO in S22), it is possible to determine that the label 90C is not included in the image. Thus, the image processing device 10 ends the process.

When the white region has been extracted (YES in S22), the brightness determination process (step S4) is performed. The brightness determination process (step S4) is the same as that shown in FIG. 12.

As a result of the brightness determination process (step S4), when it has been determined that the imaging range of the camera 20 corresponds to a bright environment (bright in S5), the detection target color determination unit 13 determines green, blue, and white as the detection target colors (S6A).

The label detection unit 14 extracts a blue region which is a detection target color region not having been extracted (S7).

The label detection unit 14 determines whether or not a blue region having a predetermined positional relationship with the green region and the white region has been extracted from the image (S8B).

When the blue region having the predetermined positional relationship has not been extracted (NO in S8B), it is possible to determine that the label 90C is not included in the image. Thus, the image processing device 10 ends the process.

When the blue region having the predetermined positional relationship has been extracted (YES in S8B), the label detection unit 14 detects the green region, the blue region, and the white region as the label 90C, and the output unit 15 outputs a detection result of the label 90C (S15).

As a result of the brightness determination process (step S4), when it has been determined that the imaging range of the camera 20 corresponds to a dark environment (dark in S5), the detection target color determination unit 13 determines red, green, and white as the detection target colors (S9A).

The label detection unit 14 extracts a red region which is a detection target color region not having been extracted (S10).

The label detection unit 14 determines whether or not a red region having a predetermined positional relationship with the green region and the white region has been extracted from the image (S11B).

When the red region having the predetermined positional relationship has not been extracted (NO in S11B), it is possible to determine that the label 90C is not included in the image. Thus, the image processing device 10 ends the process.

When the red region having the predetermined positional relationship has been extracted (YES in S11B), the label detection unit 14 detects the red region, the green region, and the white region as the label 90C, and the output unit 15 outputs a detection result of the label 90C (S15).

As a result of the brightness determination process (step S4), when it has been determined that the imaging range of the camera 20 corresponds to a medium-brightness environment (medium in S5), the detection target color determination unit 13 determines red, green, blue, and white as the detection target colors (S12A).

The label detection unit 14 extracts a red region and a blue region which are detection target color regions not having been extracted (S13A).

The label detection unit 14 determines whether or not a red region and a blue region each having a predetermined positional relationship with the green region and the white region have been extracted from the image (S14B).

When the red region and the blue region each having the predetermined positional relationship have not been extracted (NO in S14B), it is possible to determine that the label 90C is not included in the image. Thus, the image processing device 10 ends the process.

When the red region and the blue region each having the predetermined positional relationship have been extracted (YES in S14B), the label detection unit 14 detects the red region, the green region, the blue region, and the white region as the label 90C, and the output unit 15 outputs a detection result of the label 90C (S15).

The image processing device 10 repeats the processes shown in FIG. 15 in a predetermined cycle (for example, an interval of 100 msec). Accordingly, the label 90C can be detected in real time.

### Embodiment 3

In Embodiments 1 and 2, the brightness in the imaging range of the camera 20 is determined on the basis of a measurement result by the illuminance sensor. In Embodiment 3, an example in which brightness is determined without using the illuminance sensor is described.

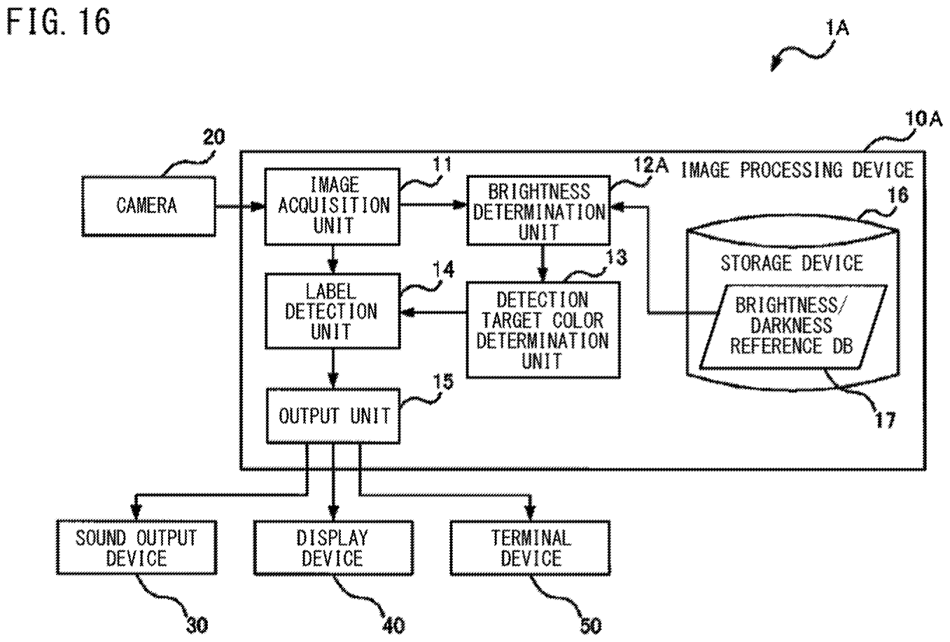

FIG. 16 is a block diagram showing a configuration of an image processing system according to Embodiment 2. An image processing system 1A shown in FIG. 16 includes an image processing device 10A instead of the image processing device 10 in the configuration of the image processing system 1 shown in FIG. 2.

The image processing device 10A is implemented by a computer, similar to the image processing device 10. The image processing device 10A includes a brightness determination unit 12A instead of the brightness determination unit 12 as a functional component.

The brightness determination unit 12A is connected to the image acquisition unit 11, and determines the brightness in the imaging range of the camera 20 on the basis of an image acquired by the image acquisition unit 11. That is, the brightness determination unit 12A calculates the average of luminance of pixels included in the image acquired by the image acquisition unit 11. Then, on the basis of the calculated luminance average, the brightness determination unit 12A determines the brightness with reference to the brightness/darkness reference DB 17 stored in the storage device 16.

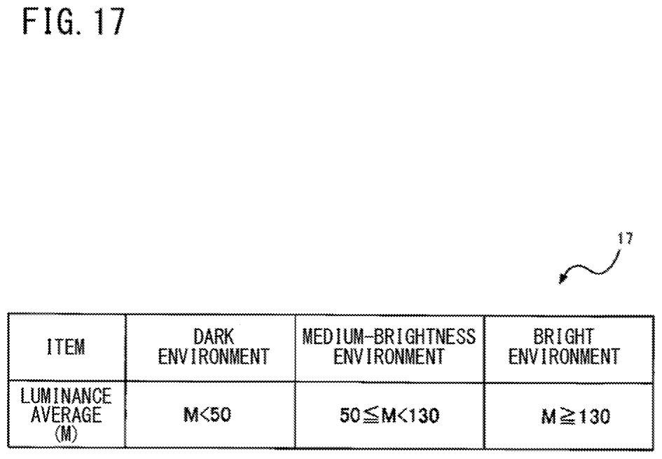

FIG. 17 shows one example of the brightness/darkness reference DB 17. The brightness/darkness reference DB 17 shows a reference for determining, on the basis of a luminance average (M), whether the environment having the luminance average is a bright environment, a dark environment, or a medium-brightness environment. For example, according to the brightness/darkness reference DB 17 shown in FIG. 17, an environment having a luminance average of M<50 is a dark environment. An environment having a luminance average of 50≤M<130 is a medium-brightness environment. An environment having a luminance average of M≥130 is a bright environment. As an example, the luminance has 256 gradations.

That is, when the calculated luminance average M is M<50, the brightness determination unit 12 determines that the imaging range of the camera 20 corresponds to a dark environment. When the luminance average M is 50≤M<130, the brightness determination unit 12 determines that the imaging range of the camera 20 corresponds to a medium-brightness environment. When the luminance average M is M≥130, the brightness determination unit 12 determines that the imaging range of the camera 20 corresponds to a bright environment. The procedure of processes performed by the image processing device 10 is the same as that in Embodiment 1 or 2.

According to Embodiment 3 of the present disclosure, brightness can be determined without using the illuminance sensor 26. Thus, the brightness can be determined at low cost.

In a case where the forklift 25 is located indoors and the camera 20 captures a bright outdoor environment, if brightness is determined using the illuminance sensor 26, the environment may be determined as a dark environment, which is different from the environment to be captured. However, when brightness is determined using the luminance average of an image, the environment is determined as a bright environment, which is the same as the environment to be captured by the camera 20. Therefore, the label can be more accurately detected.

### Embodiment 4

In Embodiments 1 and 2, the brightness in the imaging range of the camera 20 is determined on the basis of a measurement result by the illuminance sensor. In Embodiment 3, an example in which brightness is determined without using the illuminance sensor is described.

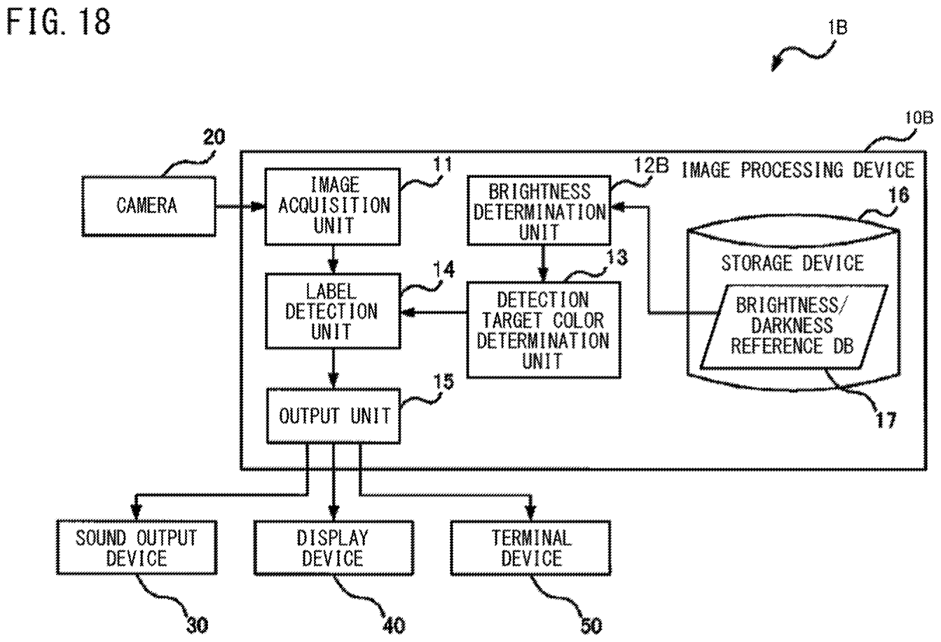

FIG. 18 is a block diagram showing a configuration of an image processing system according to Embodiment 3. An image processing system 1B shown in FIG. 18 includes an image processing device 10B instead of the image processing device 10 in the configuration of the image processing system 1 shown in FIG. 2.

The image processing device 10B is implemented by a computer, similar to the image processing device 10. The image processing device 10B includes a brightness determination unit 12B instead of the brightness determination unit 12 as a functional component.

The brightness determination unit 12B is connected to the camera 20, and determines the brightness in the imaging range of the camera 20 on the basis of imaging parameter information regarding adjustment of the brightness acquired from the camera 20. In a case where the camera 20 has a function of automatically adjusting the exposure time in accordance with the brightness in the imaging range, the brightness determination unit 12B acquires information of the exposure time (shutter speed) as the imaging parameter information from the camera 20. On the basis of the acquired exposure time, the brightness determination unit 12B determines the brightness with reference to the brightness/darkness reference DB 17 stored in the storage device 16.

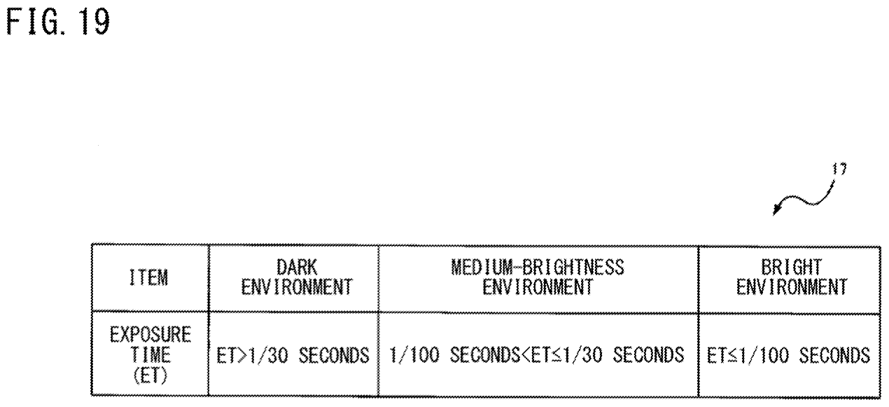

FIG. 19 shows one example of the brightness/darkness reference DB 17. The brightness/darkness reference DB 17 shows a reference for determining, on the basis of an exposure time (ET), whether the environment which has been captured by the camera 20 for the exposure time is a bright environment, a dark environment, or a medium-brightness environment. For example, according to the brightness/darkness reference DB 17 shown in FIG. 19, an environment having an exposure time of ET> 1/30 seconds is a dark environment. An environment having an exposure time of 1/100 seconds<ET≤ 1/30 seconds is a medium-brightness environment. An environment having an exposure time of ET≤ 1/100 seconds is a bright environment.

That is, when the exposure time (ET) acquired from the camera 20 is ET> 1/30 seconds, the brightness determination unit 12 determines that the imaging range of the camera 20 corresponds to a dark environment. When the exposure time (ET) is 1/100 seconds<ET≤ 1/30 seconds, the brightness determination unit 12 determines that the imaging range of the camera 20 corresponds to a medium-brightness environment. Further, when the exposure time (ET) is ET≤ 1/100 seconds, the brightness determination unit 12 determines that the imaging range of the camera 20 corresponds to a bright environment. The procedure of processes performed by the image processing device 10 are the same as that in Embodiment 1 or 2.

As the imaging parameter information, other information can be used. For example, in a case where the camera 20 has an automatic diaphragm mechanism, the brightness determination unit 12B acquires a diaphragm value (F-number) as the imaging parameter information from the camera 20. On the basis of the acquired diaphragm value, the brightness determination unit 12B determines the brightness in the imaging range of the camera 20 with reference to the brightness/darkness reference DB 17 indicating the correspondence relationship between diaphragm value and brightness. In a bright environment, the diaphragm value is increased in order to reduce the amount of light that passes through the lens. In a dark environment, the diaphragm value is decreased in order to increase the amount of light that passes through the lens.

According to Embodiment 3 of the present disclosure, brightness can be determined without using the illuminance sensor 26. Thus, the brightness can be determined at low cost.

### Modification 1

In Embodiments 1 to 3 described above, the brightness in the imaging range of the camera 20 is determined on the basis of one item among illuminance, luminance average, exposure time, and the like. However, the brightness may be determined on the basis of two or more items.

For example, on the basis of the exposure time of the camera 20, and the illuminance, in the imaging range of the camera 20, measured by the illuminance sensor 26, the brightness determination unit 12 may determine the brightness in the imaging range of the camera 20 with reference to the brightness/darkness reference DB 17.

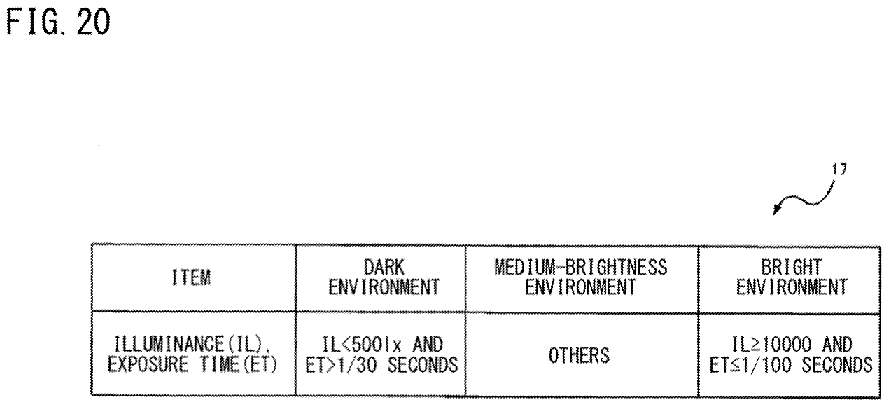

FIG. 20 shows one example of the brightness/darkness reference DB 17. The brightness/darkness reference DB 17 shows a reference for determining, on the basis of an illuminance (IL) and an exposure time (ET), whether the environment that has the illuminance and that has been captured by the camera 20 for the exposure time is a bright environment, a dark environment, or a medium-brightness environment. For example, according to the brightness/darkness reference DB 17 shown in FIG. 20, an environment having an illuminance of IL<500 lx and an exposure time of ET> 1/30 seconds is a dark environment. An environment having an illuminance of IL≥10000 and an exposure time of ET≤ 1/100 seconds is a bright environment. Other than these, the environment is a medium-brightness environment.

On the basis of the (IL) measured by the illuminance sensor 26 and the exposure time (ET) acquired from the camera 20, the brightness determination unit 12 determines the brightness in the imaging range of the camera 20 with reference to the brightness/darkness reference DB 17.

According to the present modification, the brightness in the imaging range of the camera 20 can be determined on the basis of a plurality of items. Therefore, the brightness can be more accurately determined.

### Modification 2

In Embodiments 1 to 3 described above, examples in which the label is attached to the helmet 80 have been described. However, the attachment position of the label is not limited to the helmet 80.

For example, the label may be attached to clothing, an arm band, or the like worn by a person.

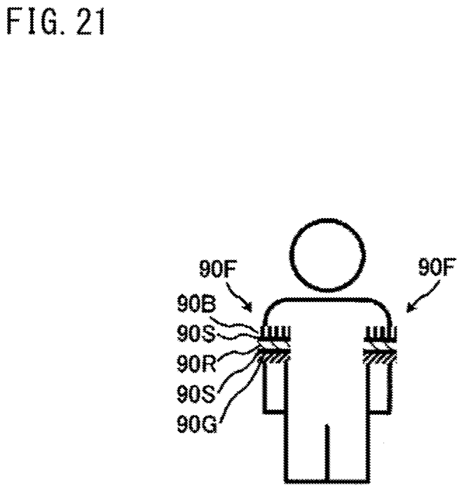

FIG. 21 shows a person viewed from the front. The person wears, in both arms, arm bands each having a label 90F attached thereto. The label 90F is formed by the blue label 90B, the red label 90R, and the green label 90G. The gap region 90S is provided between the labels.

The target to which the label is attached is not limited to a person. For example, when the image processing device 10 is used for detecting a target object, the label may be attached to the detection target object.

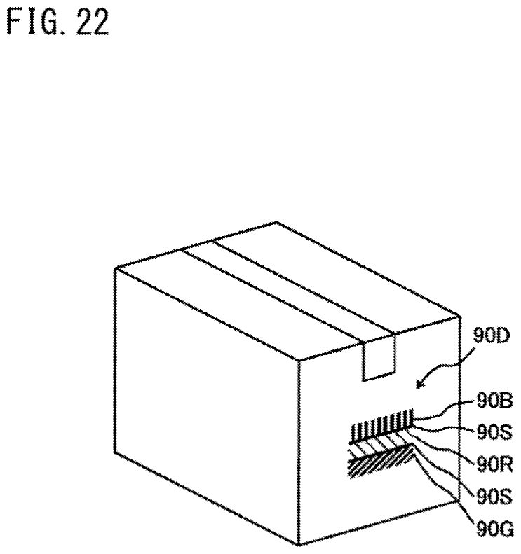

FIG. 22 is an external view of a corrugated board box. In a case where the detection target object is a corrugated board box, a label 90D is attached to the corrugated board box. The label 90D is formed by the blue label 90B, the red label 90R, and the green label 90G. The gap region 90S is provided between the labels.

When the image processing device 10 is used in order to detect a no-entry place for vehicles, the label may be attached to the no-entry place.

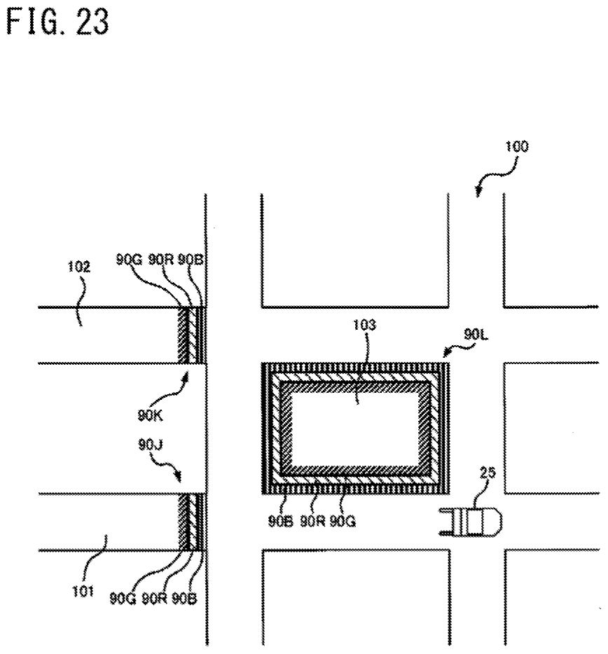

FIG. 23 is a schematic diagram showing a road on which the forklift 25 travels. For example, a road 100 on which the forklift 25 travels is provided with a no-entry road 101, a no-entry road 102, and a no-entry area 103 for which entry of the forklift 25 is prohibited. A label 90J and a label 90K are attached near the entrances of the no-entry road 101 and the no-entry road 102. A label 90L is attached around the no-entry area 103. Each of the labels 90J, 90K, and 90L is formed by the blue label 90B, the red label 90R, and the green label 90G. With this configuration, the image processing device 10 can detect that the forklift 25 has come close to a no-entry place (the no-entry road 101, the no-entry road 102, or the no-entry area 103). In order to notify the driver of the forklift 25 or a user in the surround of the forklift 25 that the forklift 25 has come close to the no-entry place, the image processing device 10 causes the sound output device 30 to output a notification sound, causes the display device 40 to display a message, or transmits, to the terminal device 50, information indicating that the forklift 25 has come close to the no-entry place.

Thus, by attaching the label to a no-entry place, it is possible to alert the driver of the forklift 25 so as not to approach the no-entry place.

As described above, by attaching the label to a target to be detected, it is possible to accurately detect the target.

(Additional Note)

A part or the entirety of components forming the image processing device 10 described above may be implemented by a single system LSI. The system LSI is an ultra-multifunctional LSI manufactured by integrating a plurality of components on a single chip, and specifically, is a computer system configured to include a microprocessor, a ROM, a RAM, and the like. Computer programs are stored in the RAM. By the microprocessor operating in accordance with the computer programs, the system LSI realizes its functions.

The present disclosure can be realized as a computer program that realizes the method described above by means of a computer. Such a computer program can be distributed in a state of being stored in a computer-readable non-transitory storage medium, such as a HDD, a CD-ROM, or a semiconductor memory, or can be transmitted via electric communication lines, wireless or wired communication lines, networks represented by the Internet, data broadcasting, and the like. The image processing device 10 may be realized by a plurality of computers.

A part or the entirety of the functions of the image processing device 10 may be provided through cloud computing. That is, a part or the entirety of the functions of the image processing device 10 may be realized by a cloud server. For example, a configuration may be employed in which the function of the label detection unit 14 in the image processing device 10 is realized by a cloud server, the image processing device 10 transmits images and information of a detection target color to the cloud server, and acquires a detection result of the label from the cloud server. Further, the above embodiments and the above modifications may be combined together.

The embodiments disclosed herein are illustrative in all aspects and should not be recognized as being restrictive. The scope of the present disclosure is defined by the scope of the claims rather than by the description above, and is intended to include meaning equivalent to the scope of the claims and all modifications within the scope.

### REFERENCE SIGNS LIST

1, 1A, 1B image processing system
10, 10A, 10B image processing device
11 image acquisition unit
12, 12A, 12B brightness determination unit
13 detection target color determination unit
14 label detection unit
15 output unit
16 storage device
17 brightness/darkness reference DB
20 camera
21 imaging region
22 dead angle region
25 forklift
26, 26A illuminance sensor
30 sound output device
40 display device
50 terminal device
60 mirror
61 imaging region
71, 72 person
80 helmet
82G green region
82R red region
83 centroid position
84 predetermined distance range
90A, 90C, 90D, 90F, 90J, 90K, 90L label
90B blue label
90G green label
90R red label
90S gap region
90W white label
100 road
101, 102 no-entry road
103 no-entry area

1. An image processing device comprising:
an image acquisition unit configured to acquire a color image captured by a camera;
a brightness determination unit configured to determine a brightness in an imaging range of the camera;
a detection target color determination unit configured to determine, on the basis of a determination result by the brightness determination unit, detection target colors of two or more colors from among three or more colors provided to a label including regions of the three or more colors; and
a label detection unit configured to detect the label by extracting, from the image acquired by the image acquisition unit, regions of the detection target colors determined by the detection target color determination unit.

2. The image processing device according to claim 1, wherein
the brightness determination unit determines the brightness on the basis of at least one of
the image acquired by the image acquisition unit,
imaging parameter information regarding adjustment of a brightness acquired from the camera, and
illuminance information acquired from an illuminance sensor configured to measure an illuminance at a position included in the imaging range of the camera.

3. The image processing device according to claim 1, wherein
the detection target color determination unit determines, as one of the detection target colors, at least an intermediate wavelength color which is a color other than a color having a longest wavelength and a color having a shortest wavelength among the three or more colors.

4. The image processing device according to claim 3, wherein
starting from a region of the intermediate wavelength color, the label detection unit sequentially extracts the regions of the detection target colors.

5. The image processing device according to claim 1, wherein
the label includes a red region, a blue region, and a green region.

6. The image processing device according to claim 1, further comprising
an output unit configured to output information according to a detection result by the label detection unit.

7. A non-transitory computer readable storage medium storing a computer program configured to cause a computer to function as:
an image acquisition unit configured to acquire a color image captured by a camera;
a brightness determination unit configured to determine a brightness in an imaging range of the camera;
a detection target color determination unit configured to determine, on the basis of a determination result by the brightness determination unit, detection target colors of two or more colors from among three or more colors provided to a label including regions of the three or more colors; and
a label detection unit configured to detect the label by extracting, from the image acquired by the image acquisition unit, regions of the detection target colors determined by the detection target color determination unit.

8. An image processing system comprising:
a label including regions of three or more colors, the label configured to be attached to a detection target object;
a camera configured to capture a color image; and
the image processing device according to claim 1.
